(19) United States
(12) Patent Application Publication
(10) Pub. No.: US 2013/0344275 A1
(43) Pub. Date: Dec. 26, 2013

(54) DECORATION FILM HAVING MIRROR EFFECT

(71) Applicant: LG Electronics Inc., Seoul (KR)

(72) Inventors: Jiwon SHIN, Seoul (KR); Seokjae JEONG, Seoul (KR); Hyungi JUNG, Seoul (KR)

(21) Appl. No.: 13/920,277

(22) Filed: Jun. 18, 2013

(30) Foreign Application Priority Data
Jun. 22, 2012 (KR) 10-2012-0067074

(51) Int. Cl. B32B 7/12; B32B 7/06; B32B 3/10

(52) U.S. Cl. CPC B32B 7/12; B32B 3/10; B32B 7/06
USPC 428/41.7; 428/195.1; 156/277; 428/201

(57) ABSTRACT

A decoration film having a mirror effect is used in decoration panels of various home appliances or other devices. A decoration film includes a printing layer, a first base layer, and a second base layer that is adhered to the first base layer. The first base layer is a non-conductive mirror polyethylene terephthalate (PET) film and the second base layer is a scattering prevention film. The printing layer, the first base material layer, and the second base material layer are sequentially laminated. The decoration film also includes a gluing agent configured to enable the decoration film to be attached to a glass panel, thereby obtaining a panel with a mirror effect.

### CROSS-REFERENCE TO RELATED APPLICATION

This application claims priority from Korean Application No. 10-2012-0067074, filed Jun. 22, 2012, the subject matter of which is incorporated herein by reference.

### FIELD

The present disclosure relates to a decoration film having a mirror effect, which may be used in decoration panels or the like of various home appliances, such as a refrigerator, an air conditioner, and a washing machine.

### BACKGROUND

In general, a main body or door made of steel iron, plastic, or the like is used in various types of home appliances, such as a refrigerator, an air conditioner, a washing machine, a cooking appliance, an air-conditioning system and a dish washer. A decoration panel capable of representing various colors, textures, patterns, etc. may be mounted at the front side of the main body or door.

In addition to unique functions of home appliances, the external appearances and designs of the home appliances may be important factors in customers' purchase decisions. For example, nickel (Ni) is directly deposited on a rear side of glass in order to provide a mirror effect to a decoration panel of a home appliance, such as a refrigerator.

FIGS. 1 and 2 illustrate the laminated structure and manufacturing process of a conventional decoration panel. Nickel (Ni) is directly deposited on a lower surface of a blue glass (or green glass) 10 (S10). The blue glass 10 may be used instead of white glass because blue glass is generally less expensive than white glass. A printing layer 12 is formed, using a silk screen method (S11), on a lower surface of a Ni deposition layer 11 formed by depositing the nickel (Ni). Then, a base material layer 14 made of a PVC material is adhered to a lower surface of the printing layer 12, using an adhesive 13 (S12), thereby completing the decoration panel having a mirror effect (S13).

However, in a case where nickel (Ni) is directly deposited on the lower surface of the blue glass 10 as described above, the failure rate of the decoration panel in the Ni deposition process may be relatively high. Further, since the manufacturing process of the decoration panel is of a discontinuous batch type, the productivity of the decoration panel may be relatively low, and therefore, manufacturing cost may be increased.

Moreover, in a case where the nickel (Ni) is directly deposited on the lower surface of the blue glass 10 as described above, the decoration panel may be entirely conductive. Hence, as shown in FIG. 3, a partial region is removed to accommodate a manipulation portion (B of FIG. 3) that receives user input. The partial region is removed to reduce the likelihood of malfunction caused by the conductivity of the decoration panel. Therefore, the operating process of the decoration panel may be complicated, and the productivity of the decoration panel may be lowered.

### SUMMARY

In one aspect, a decoration film includes a first base layer, a second base layer, and a printing layer. The first base layer is a non-conductive mirror polyethylene terephthalate (PET) film. The second base layer is a scattering prevention film and is adhered to the first base layer by an adhesive. The printing layer, the first base layer, and the second base layer are sequentially laminated. The decoration film also includes a gluing agent configured to enable the decoration film to be attached to a glass panel, thereby obtaining a panel with a mirror effect.

Implementations may include one or more of the following features. For example, the decoration film may include a third base layer. In this example, the third base layer may be a PET film and the printing layer may be formed on a first surface of the third base layer. Also, in this example, the gluing agent may be coated on a second surface of the third base layer and the printing layer may be adhered to the first base layer by an adhesive coated on a surface of the printing layer. Further, in this example, the PET film may be an optical PET film having high optical transmittance.

In some implementations, the decoration film may include a third base layer. In these implementations, the third base layer may be a PET film and the gluing agent may be coated on a surface of the third base layer. Also, in these implementations, the printing layer may be formed on a surface of the first base layer and the third base layer may be adhered to the first base layer by an adhesive. Further, in these implementations, the PET film may be an optical PET film having high optical transmittance.

In addition, the non-conductive mirror PET film may include a plurality of polymer layers having different refractive indices and thicknesses. The printing layer may be formed using a micro gravure method. The gluing agent may include an optical clear adhesive (OCA).

In some examples, the decoration film may include a protective film adhered on the gluing agent. In these examples, the protective film may be configured to separate from the gluing agent in a process of attaching the decoration film to the glass panel. Further, in these examples, the gluing agent may include a double-faced tape, the protective film may be attached to a first side of the double-faced tape, and OCA may be coated on a second side of the double-faced tape that is opposite of the first side of the double-faced tape.

The scattering prevention film may be one of a polyethylene (PE) film and a poly vinyl chloride (PVC) film. The decoration film may be a roll-type decoration film.

In another aspect, a method of manufacturing a decoration film includes forming a printing layer on a first base layer. The first base layer is a non-conductive mirror PET film. The method also includes coating an adhesive on a surface of the first base layer that is opposite of the printing layer and adhering a second base layer to the first base layer using the adhesive coated on the surface of the first base layer. The second base layer is a scattering prevention film. The method further includes adhering a protective film to the printing layer using a gluing agent that has high optical transmittance and that is coated on the protective film.

In yet another aspect, a method of manufacturing a decoration film includes forming a printing layer on a first surface of a first base layer. The first base layer is a PET film. The method also includes coating an adhesive on a surface of the printing layer and adhering a second base layer to the printing layer using the adhesive coated on the surface of the printing layer. The second base layer is a non-conductive mirror PET film. The method further includes coating an adhesive on a surface of the second base layer and adhering a third base layer to the second base layer using the adhesive coated on the surface of the second base layer. The third base layer is a scattering prevention film. In addition, the method includes adhering a protective film to a second surface of the first base layer using a gluing agent that has high optical transmittance and that is coated on the protective film. The second surface of the first base layer is opposite of the first surface of the first base layer.

In a further aspect, a method of manufacturing a decoration film includes forming a printing layer on a surface of a second base layer. The second base layer is a non-conductive mirror PET film. The method also includes coating an adhesive on a surface of the printing layer and adhering a first base layer to the printing layer using the adhesive coated on the surface of the printing layer. The first base layer is a PET film. The method further includes coating an adhesive on a surface of the second base layer and adhering a third base layer to the second base layer using the adhesive coated on the surface of the second base layer. The third base layer is a scattering prevention film. In addition, the method includes adhering a protective film to a surface of the first base layer using a gluing agent that has high optical transmittance and that is coated on the protective film.

In another aspect, a decoration panel includes a glass panel and a decoration film. The decoration film includes a first base layer, a second base layer, and a printing layer. The first base layer is a non-conductive mirror PET film. The second base layer is a scattering prevention film and is adhered to the first base layer by an adhesive. The printing layer, the first base layer, and the second base layer are sequentially laminated. The decoration film also includes a gluing agent that attaches the decoration film to the glass panel, thereby obtaining a mirror effect.

Implementations may include one or more of the following features. For example, the decoration film may include a third base layer. In this example, the third base layer may be a PET film and the printing layer being formed on a first surface of the third base layer. Further, in this example, the gluing agent may be coated on a second surface of the third base layer and the printing layer may be adhered to the first base layer by an adhesive coated on a surface of the printing layer.

In some implementations, the decoration film may include a third base layer. In these implementations, the third base layer may be a PET film and the gluing agent may be coated on a surface of the third base layer. Further, in these implementations, the printing layer may be formed on a surface of the first base layer and the third base layer may be adhered to the first base layer by an adhesive.

In addition, the non-conductive mirror PET film may include a plurality of polymer layers having different refractive indices and thicknesses. Also, the printing layer may be formed using a micro gravure method.

The details of one or more implementations are set forth in the accompanying drawings and the description below. Other features will be apparent from the description and drawings, and from the claims.

### BRIEF DESCRIPTION OF THE DRAWINGS

FIG. 1 illustrates a laminated structure of a conventional decoration panel of a home appliance;

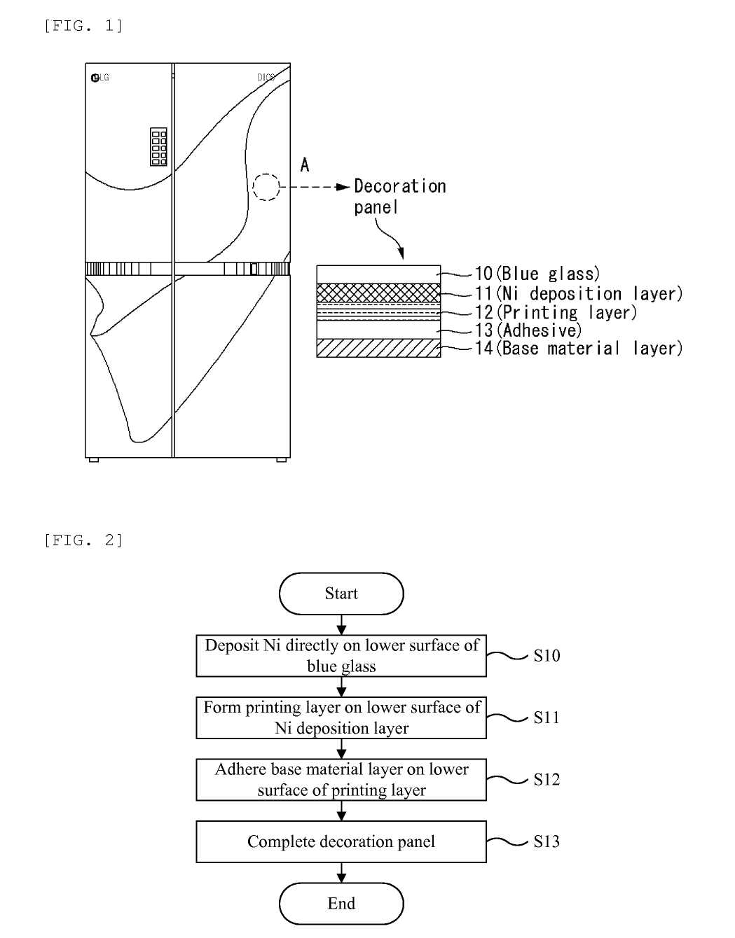

FIG. 2 is a flowchart illustrating a process of manufacturing the conventional decoration panel of the home appliance;

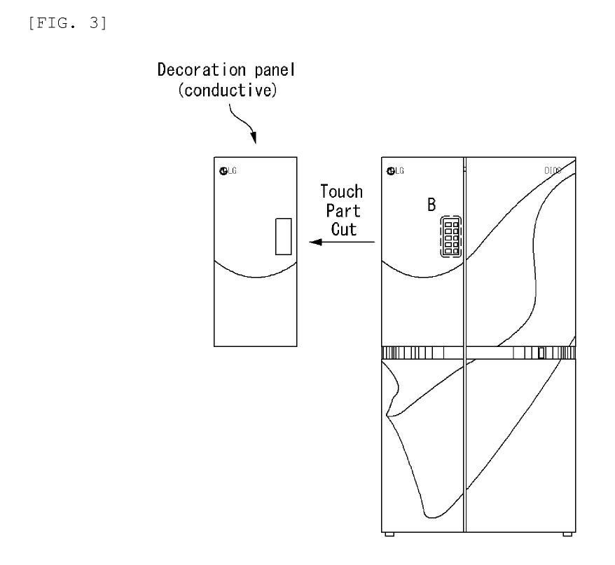

FIG. 3 illustrates an example of removing a partial region of the decoration panel shown in FIG. 1;

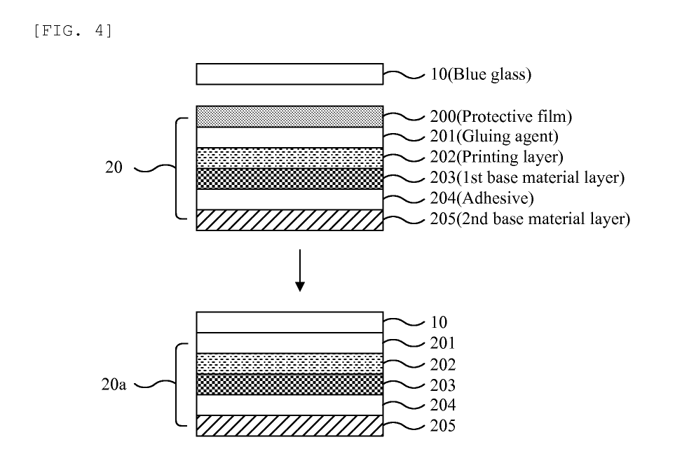

FIG. 4 illustrates an example laminated structure of an example decoration film;

FIG. 5 illustrates characteristics of reflectance with respect to frequency of a non-conductive mirror polyethylene terephthalate (PET) film;

FIGS. 6 and 7 are flowcharts illustrating an example process of manufacturing the example decoration film shown in FIG. 4;

FIG. 8 illustrates an example laminated structure of another example decoration film;

FIG. 9 is a flowchart illustrating an example process of manufacturing the example decoration film shown in FIG. 8;

FIG. 10 illustrates an example laminated structure of yet another example decoration film; and

FIG. 11 is a flowchart illustrating an example process of manufacturing the example decoration film shown in FIG. 10.

### DETAILED DESCRIPTION

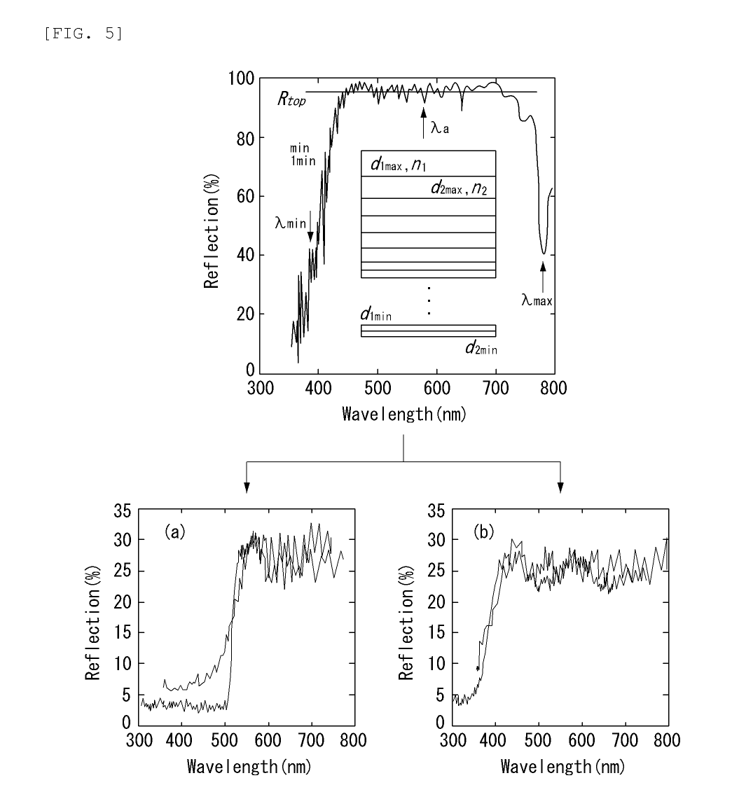

FIG. 4 illustrates an example laminated structure of an example decoration film 20. For example, a glass 10 can be used for a decoration panel of a home appliance, such as a refrigerator. In this example, the glass 10 may be white glass or blue glass, which is generally less expensive than white glass.

A decoration film 20a having a protective film 200 removed therefrom is attached to a rear side of the blue glass 10 by a gluing agent 201, thereby forming a mirror effect. As shown in FIG. 4, the decoration film 20 has a structure in which the protective film 200, the gluing agent 201, a printing layer 202, a first base material layer 203, an adhesive 204 and a second base material layer 205 are laminated.

The protective film 200 is a simple cover film attached to the gluing agent 201 in order to keep the decoration film as a roll-type film. The protective film 200 may be separated by a continuous roll-to-roll type manufacturing process of attaching the decoration film 20a to the rear side of the blue glass 10.

The gluing agent 201 is coated on the printing layer 202 in order to allow the decoration film 20a to be adhered to the rear side of the blue glass 10. The gluing agent 201 can include a roll-type gluing agent having high optical transmittance, e.g., an optical clear adhesive (OCA) that is an optical transparent double-faced tape. The gluing agent 201 can have a structure in which the protective film is attached to one face of the optical transparent double-faced tape and a gluing agent having high transmittance is coated on the other face of the optical transparent double-faced tape.

The printing layer 202 is printed on the first base material layer 203, using a gravure method, so as to design a color of the decoration panel. In order to design a more luxurious color of the decoration panel, a micro gravure method having a printing density higher than that of a general gravure method can be applied to the printing layer 202.

The first base material layer 203 is a roll-type film that has the mirror effect without directly depositing nickel (Ni) on the rear side of the blue glass and has a characteristic of non-conductivity. The first base material layer 203 can include a non-conductive mirror polyethylene terephthalate (PET) film.

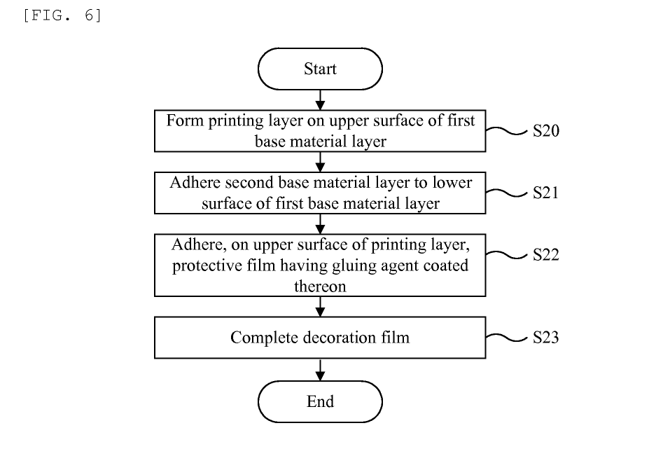

As shown in FIG. 5, the non-conductive mirror PET film simultaneously has the mirror effect and the characteristic of non-conductivity by laminating several polymer layers having different refractive indices (n) and thicknesses d. Wavelength bands in a visual light region are almost totally reflected, and the other wavelength bands are absorbed, and hence the mirror effect is obtained.

The wavelength (nm) of reflected light is changed depending on the refractive indices (n) and thicknesses (d) of the laminated polymer layers, and thus the reflection and color of the non-conductive mirror PET film can be controlled as shown in FIG. 5. The second base material layer 205 is adhered to a lower surface of the first base material layer 203 by the adhesive 204. In this case, the second base material layer 205 is a scattering prevention film for protecting a film laminated thereon and allowing the film to be adhered even after glass is broken. The second base material layer 205 can include any one of a polyethylene (PE) film and a poly vinyl chloride (PVC) film.

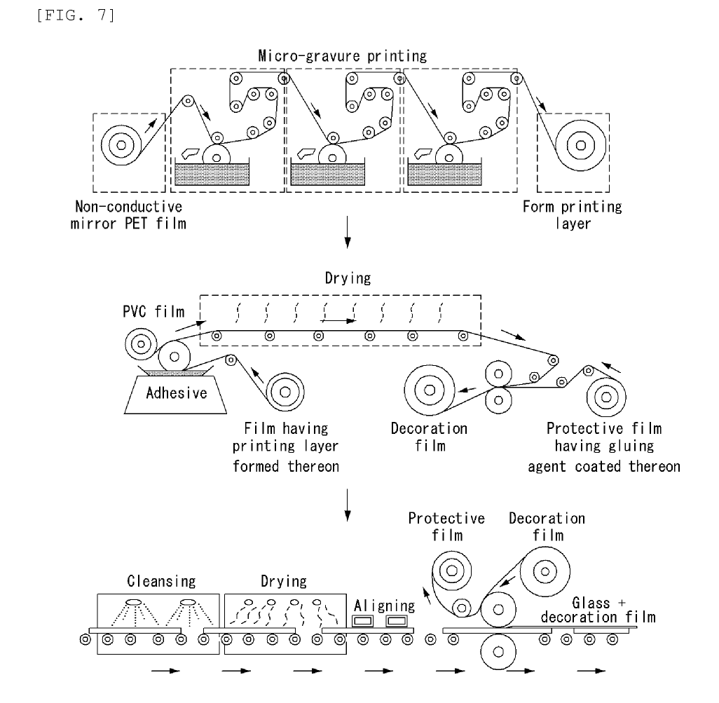

FIGS. 6 and 7 illustrate an example process of manufacturing the decoration film. First, the printing layer 202 is formed on an upper surface of the first base material layer 203 that is the non-conductive mirror PET film simultaneously having the mirror effect and the characteristic of non-conductivity as described above, using a micro gravure method (S20), thereby designing a luxurious color of the decoration panel.

The adhesive 204 is coated on the lower surface of the first base material layer 203, and the second base material layer 205 as a scattering prevention film, including any one of the PE film and the PVC film, is adhered to the first base material layer 203 (S21).

The OCA that is a roll-type optical transparent double-faced tape having high optical transmittance is attached to the upper surface of the printing layer 202. For example, the protective film 200 is attached to one surface of the printing layer 202, and the optical transparent double-faced tape, on which the gluing agent having high optical transmittance is coated, is adhered to the upper surface that is the other surface of the printing layer 202 (S22), thereby completing the roll-type decoration film 20 (S23).

That is, the decoration film 20, as shown in FIG. 7, is produced by a continuous roll-to-roll manufacturing process. In the manufacturing process, the printing layer 202 is formed on the upper surface of the non-conductive mirror PET film through multi stages, using the micro gravure method.

The PVC film or PE film is adhered to the non-conductive mirror PET film having the printing layer formed thereon by coating an adhesive on the lower surface of the non-conductive mirror PET film, and a drying process is then performed. Subsequently, a protective film, on which a gluing agent having high optical transmittance is coated, is adhered on the upper surface of the printing layer, thereby completing the decoration film.

A blue glass to which the decoration film is to be attached, as shown in FIG. 7, passes through a preprocess including cleansing, drying, aligning and the like. Subsequently, the protective film attached to the uppermost layer of the decoration film 20 is separated from the decoration film 20, so that the decoration panel is continuously produced through a simple manufacturing process in which the decoration film 20a is adhered to the rear side of the blue glass.

Thus, the process of directly depositing the nickel (Ni) on the rear side of the blue glass is removed, and the decoration film is manufactured through the continuous roll-type manufacturing process other than a discontinuous batch-type manufacturing process, so that it may be possible to decrease the failure rate of the decoration panel and to improve the productivity of the decoration panel.

Furthermore, since the decoration panel is non-conductive, it may be unnecessary to separately remove a partial region at which a manipulation portion to be touched with a user's hand is mounted.

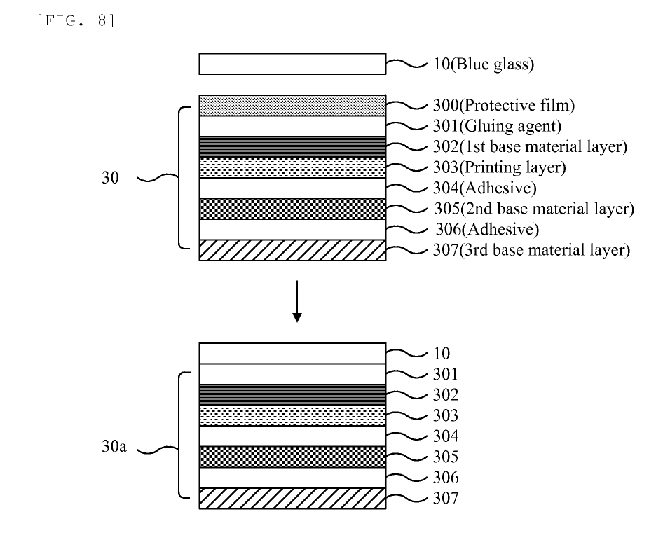

FIG. 8 illustrates an example laminated structure of another decoration film.

As shown in FIG. 8, the decoration film 30 has a structure in which a protective film 300, a gluing agent 301, a first base material layer 302, a printing layer 303, an adhesive 304, a second base material layer 305, an adhesive 306, and a third base material layer 307 are laminated.

In the decoration film of FIG. 8, the protective film 300, the gluing agent 301, the printing layer 303, the second base material layer 305, the adhesive 306, and the third base material layer 307 may be identical to the components shown in FIG. 4.

In some implementations, the first base material layer 302 is a roll-type PET film and can include an optical PET film having high optical transmittance. The printing layer 303 is printed on a lower surface of the first base material layer 302, using a gravure method, thereby designing a color of the decoration panel.

The second base material layer 305 is adhered to the lower surface of the printing layer 303 by the adhesive 304. In this case, the second base material layer 305 can include a non-conductive mirror PET film as a roll-type film made of the same material as the first base material layer 203 described above.

Like the second base material layer 205 described above, the third base material layer 307 can include any one of the PE film and the PVC film.

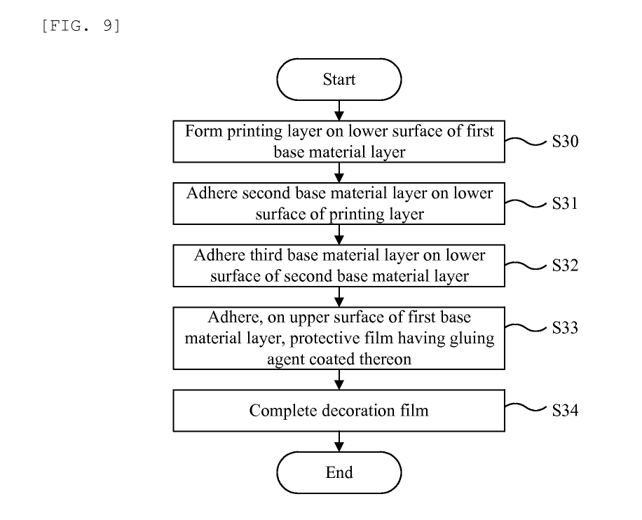

FIG. 9 illustrates an example process of manufacturing the decoration film shown in FIG. 8. As described above, the printing layer 303 is formed on the lower surface of the first base material 302 that is a roll-type PET film, using a micro gravure method (S30), thereby designing a luxurious color of the decoration panel.

The adhesive 304 is coated on the lower surface of the printing layer 303, and the second base material layer 305 that is the non-conductive mirror PET film simultaneously having the mirror effect and the characteristic of non-conductivity is then adhered to the printing layer 304 (S31). Subsequently, the adhesive 306 is coated on the lower surface of the second base material layer 305, and the third base material layer as a scattering prevention layer, including any one of the PE film or the PVC film, is then adhered to the second base material layer 305.

Then, the OCA that is a roll-type transparent double-faced tape having high optical transmittance is adhered to the upper surface of the first base material layer 302 (S33), thereby completing the roll-type decoration film 30 (S34).

The printing layer 303 may be formed on the lower surface of the first base material layer 302 that is the PET film laminated on the non-conductive mirror PET film, so that the gluing agent 301 and the printing layer 303 do not come in contact with each other. Accordingly, it may be possible to reduce (e.g., prevent) in advance the possibility that a decolorization phenomenon or the like can occur due to a chemical reaction.

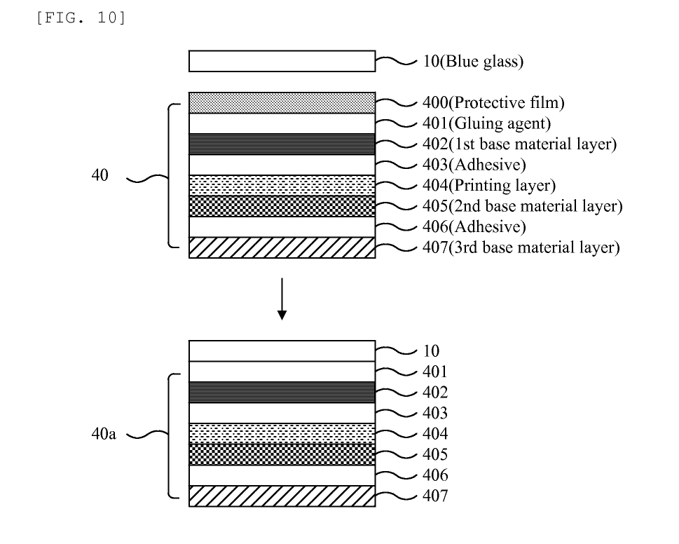

FIG. 10 illustrates an example laminated structure of yet another decoration film.

The decoration film 40 has a structure in which a protective film 400, a gluing agent 401, a first base material 402, an adhesive 403, a printing layer 404, a second base material layer 405, an adhesive 406, and a third base material layer 407 are laminated.

In the decoration film of FIG. 10, the protective film 400, the gluing agent 401, the printing layer 404, the second base material layer 405, the adhesive 406, and the third base material layer 407 may be identical to the components shown in FIG. 4. The second base material layer 405, the adhesive 406, and the third base material layer 407 also may be identical to the second base material layer 305, the adhesive 306, and the third base material layer 307 described above.

In some examples, the first base material layer 402 is a roll-type PET film and can include an optical PET film having high optical transmittance. The second base material layer 405 having the printing layer 404 formed thereon is adhered to a lower surface of the first base material layer 402 by the adhesive 403.

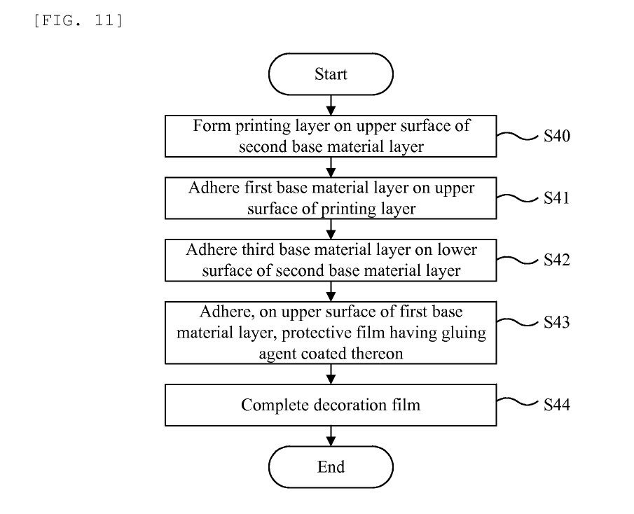

FIG. 11 illustrates an example process of manufacturing the decoration film shown in FIG. 10. As described above, the printing layer 404 is formed on an upper surface of the second base material layer 405 that is a non-conductive mirror PET film simultaneously having a mirror effect and a characteristic of non-conductivity, using a micro gravure method (S40), thereby designing a luxurious color of the decoration panel.

The adhesive 403 is coated on an upper surface of the printing layer 404, and the first base material layer 402 that is an optical PET film having high optical transmittance is then adhered to the printing layer 404 (S41). Subsequently, the third base material layer 407 as a scattering prevention layer, including any one of the PE film or the PVC film, is adhered to the lower surface of the second base material layer 405 (S42).

Then, the protective film 400 is attached to the upper surface, e.g., one surface of the first base material layer 402, and an optical transparent double-face tape, on which a gluing agent having high optical transmittance is coated, is adhered to the upper surface of the first base material layer 402 (S43), thereby completing the roll-type decoration film 40 (S44).

The printing layer 404 formed on the second base material layer 405 that is the non-conductive mirror PET film is protected by the first base material layer 402 that is the optical PET film having high optical transmittance, so that the gluing agent 401 and the printing layer 404 do not come in contact with each other. Accordingly, it may be possible to reduce (e.g., prevent) in advance the possibility that a decolorization phenomenon or the like can occur due to a chemical reaction.

The decoration panels described throughout this disclosure can be applied not only to decoration panels of home appliances, such as a refrigerator, a washing machine, and an air conditioner, but also to various types of electronic devices, such as a smart phone.

As described above, structure and operational examples have been described in detail with reference to appended drawings. However, the disclosure is not limited to the above and various modifications and different implementations are possible and fall within the scope of the disclosure. Therefore, actual scope should be determined by what is defined by the appended claims.

Since the roll-type decoration film, in which a base material layer that is a non-conductive mirror PET film is laminated, is used, it may be unnecessary to directly deposit nickel (Ni) on a lower surface of blue glass, thereby potentially decreasing the failure rate of the decoration panel.

Further, it may be possible to improve the productivity of the decoration panel through a continuous roll-type manufacturing process.

Further, since the decoration panel entirely has non-conductivity, it may be unnecessary to separately remove a partial region at which a manipulation portion to be touched with a user's hand is mounted. Accordingly, it may be possible to improve the productivity of the decoration panel by more efficiently performing and simplifying the manufacturing process of the decoration panel.

What is claimed is:

1. A decoration film, comprising:
a first base layer, the first base layer being a non-conductive mirror polyethylene terephthalate (PET) film;
a second base layer, the second base layer being a scattering prevention film and being adhered to the first base layer by an adhesive;
a printing layer, the printing layer, the first base layer, and the second base layer being sequentially laminated; and
a gluing agent configured to enable the decoration film to be attached to a glass panel, thereby obtaining a panel with a mirror effect.

2. The decoration film of claim 1, further comprising a third base layer, the third base layer being a PET film and the printing layer being formed on a first surface of the third base layer,
wherein the gluing agent is coated on a second surface of the third base layer, and
wherein the printing layer is adhered to the first base layer by an adhesive coated on a surface of the printing layer.

3. The decoration film of claim 2, wherein the PET film is an optical PET film having high optical transmittance.

4. The decoration film of claim 1, further comprising a third base layer, the third base layer being a PET film and the gluing agent being coated on a surface of the third base layer,
wherein the printing layer is formed on a surface of the first base layer and the third base layer is adhered to the first base layer by an adhesive.

5. The decoration film of claim 4, wherein the PET film is an optical PET film having high optical transmittance.

6. The decoration film of claim 1, wherein the non-conductive mirror PET film comprises a plurality of polymer layers having different refractive indices and thicknesses.

7. The decoration film of claim 1, wherein the printing layer is formed using a micro gravure method.

8. The decoration film of claim 1, wherein the gluing agent includes an optical clear adhesive (OCA).

9. The decoration film of claim 1, further comprising a protective film adhered on the gluing agent,
the protective film being configured to separate from the gluing agent in a process of attaching the decoration film to the glass panel.

10. The decoration film of claim 8, wherein the gluing agent comprises a double-faced tape, and
wherein the protective film is attached to a first side of the double-faced tape, and OCA is coated on a second side of the double-faced tape, the second side of the double-faced tape being opposite of the first side of the double-faced tape.

11. The decoration film of claim 1, wherein the scattering prevention film is one of a polyethylene (PE) film and a poly vinyl chloride (PVC) film.

12. The decoration film of claim 1, wherein the decoration film is a roll-type decoration film.

13. A method of manufacturing a decoration film, comprising:
forming a printing layer on a first base layer, the first base layer being a non-conductive mirror PET film;
coating an adhesive on a surface of the first base layer that is opposite of the printing layer;
adhering a second base layer to the first base layer using the adhesive coated on the surface of the first base layer, the second base layer being a scattering prevention film; and
adhering a protective film to the printing layer using a gluing agent that has high optical transmittance and that is coated on the protective film.

14. A method of manufacturing a decoration film, comprising:
forming a printing layer on a first surface of a first base layer, the first base layer being a PET film;
coating an adhesive on a surface of the printing layer;
adhering a second base layer to the printing layer using the adhesive coated on the surface of the printing layer, the second base layer being a non-conductive mirror PET film;
coating an adhesive on a surface of the second base layer;
adhering a third base layer to the second base layer using the adhesive coated on the surface of the second base layer, the third base layer being a scattering prevention film; and
adhering a protective film to a second surface of the first base layer using a gluing agent that has high optical transmittance and that is coated on the protective film, the second surface of the first base layer being opposite of the first surface of the first base layer.

15. A method of manufacturing a decoration film, comprising:
forming a printing layer on a surface of a second base layer, the second base layer being a non-conductive mirror PET film;
coating an adhesive on a surface of the printing layer;
adhering a first base layer to the printing layer using the adhesive coated on the surface of the printing layer, the first base layer being a PET film;
coating an adhesive on a surface of the second base layer;
adhering a third base layer to the second base layer using the adhesive coated on the surface of the second base layer, the third base layer being a scattering prevention film; and
adhering a protective film to a surface of the first base layer using a gluing agent that has high optical transmittance and that is coated on the protective film.

16. A decoration panel comprising:
a glass panel; and
a decoration film, the decoration film comprising:
a first base layer, the first base layer being a non-conductive mirror PET film;
a second base layer, the second base layer being a scattering prevention film and being adhered to the first base layer by an adhesive;
a printing layer, the printing layer, the first base layer, and the second base layer being sequentially laminated; and
a gluing agent that attaches the decoration film to the glass panel, thereby obtaining a mirror effect.

17. The decoration panel of claim 16, wherein the decoration film further comprises a third base layer, the third base layer being a PET film and the printing layer being formed on a first surface of the third base layer,
wherein the gluing agent is coated on a second surface of the third base layer, and
wherein the printing layer is adhered to the first base layer by an adhesive coated on a surface of the printing layer.

18. The decoration panel of claim 16, wherein the decoration film further comprises a third base layer, the third base layer being a PET film and the gluing agent being coated on a surface of the third base layer,
wherein the printing layer is formed on a surface of the first base layer and the third base layer is adhered to the first base layer by an adhesive.

19. The decoration panel of claim 16, wherein the non-conductive mirror PET film comprises a plurality of polymer layers having different refractive indices and thicknesses.

20. The decoration panel of claim 16, wherein the printing layer is formed using a micro gravure method.
